(19) United States
(12) Patent Application Publication
(10) Pub. No.: US 2025/0324378 A1
(43) Pub. Date: Oct. 16, 2025

(54) TECHNOLOGIES FOR LOCAL ROUTING OF PERSONAL INTERNET OF THINGS NETWORK COMMUNICATIONS

(71) Applicant: Apple Inc., Cupertino, CA (US)

(72) Inventors: Sudeep Manithara Vamanan, Nuremberg (DE); Behrouz Aghili, San Diego, CA (US); Biljana Badic, Munich (DE); Haijing Hu, Los Gatos, CA (US); Krisztian Kiss, Rancho Santa Fe, CA (US); Mona Agnel, Guildford Surrey (GB); Vivek G. Gupta, San Jose, CA (US)

(73) Assignee: Apple Inc., Cupertino, CA (US)

(21) Appl. No.: 18/862,908

(22) PCT Filed: Apr. 21, 2023
(86) PCT No.: PCT/US2023/019463

§ 371 Date: Nov. 4, 2024

Related U.S. Application Data
(60) Provisional application No. 63/338,819, filed on May 5, 2022.

(51) Int. Cl. H04W 60/04; H04W 8/22; H04W 28/02; H04W 48/18

(52) U.S. Cl. CPC H04W 60/04; H04W 8/22; H04W 28/0268; H04W 48/18

(57) ABSTRACT

The present application relates to devices and components including apparatus, systems, and methods for internal routing of personal Internet of things network communications.

### CROSS REFERENCE TO RELATED APPLICATION

This application claims priority to U.S. Provisional Application No. 63/338,819 filed May 5, 2022, which is hereby incorporated by reference in its entirety.

### FIELD

The present application relates to the field of network communications and, in particular, to technologies for local routing of personal internet of things communications.

### BACKGROUND

Third Generation Partnership Project (3GPP) Technical Specifications (TSs) define standards for New Radio (NR) wireless networks. One area of study for developing these TSs is for enhancing Fifth Generation (5G) systems to support communications with respect to personal Internet of things Networks (PINs).

### BRIEF DESCRIPTION OF THE DRAWINGS

FIG. 1 illustrates a network environment in accordance with some embodiments.

FIG. 2 illustrates a flow diagram in accordance with some embodiments.

FIG. 3 illustrates a user plane function (UPF) in accordance with some embodiments.

FIG. 4 illustrates an operation flow/algorithmic structure in accordance with some embodiments.

FIG. 5 illustrates another operation flow/algorithmic structure in accordance with some embodiments.

FIG. 6 illustrates another operation flow/algorithmic structure in accordance with some embodiments.

FIG. 7 illustrates a PIN element in accordance with some embodiments. FIG. 8 illustrates a network node in accordance with some embodiments.

### DETAILED DESCRIPTION

The following detailed description refers to the accompanying drawings. The same reference numbers may be used in different drawings to identify the same or similar elements. In the following description, for purposes of explanation and not limitation, specific details are set forth such as particular structures, architectures, interfaces, and techniques in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrases “A/B” and “A or B” mean (A), (B), or (A and B).

The following is a glossary of terms that may be used in this disclosure.

The term “circuitry” as used herein refers to, is part of, or includes hardware components that are configured to provide the described functionality. The hardware components may include an electronic circuit, a logic circuit, a processor (shared, dedicated, or group) or memory (shared, dedicated, or group), an application specific integrated circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable system-on-a-chip (SoC)), or a digital signal processor (DSP). In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, or transferring digital data. The term “processor circuitry” may refer an application processor, baseband processor, a central processing unit (CPU), a graphics processing unit, a single-core processor, a dual-core processor, a triple-core processor, a quad-core processor, or any other device capable of executing or otherwise operating computer-executable instructions, such as program code, software modules, or functional processes.

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, and network interface cards.

The term “user equipment” or “UE” as used herein refers to a device with radio communication capabilities that may allow a user to access network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, or reconfigurable mobile device. Furthermore, the term “user equipment” or “UE” may include any type of wireless/wired device or any computing device including a wireless communications interface.

The term “computer system” as used herein refers to any type interconnected electronic devices, computer devices, or components thereof. Additionally, the term “computer system” or “system” may refer to various components of a computer that are communicatively coupled with one another. Furthermore, the term “computer system” or “system” may refer to multiple computer devices or multiple computing systems that are communicatively coupled with one another and configured to share computing or networking resources.

The term “resource” as used herein refers to a physical or virtual device, a physical or virtual component within a computing environment, or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, or workload units. A “hardware resource” may refer to compute, storage, or network resources provided by physical hardware elements. A “virtualized resource” may refer to compute, storage, or network resources provided by virtualization infrastructure to an application, device, or system. The term “network resource” or “communication resource” may refer to resources that are accessible by computer devices/systems via a communications network. The term “system resources” may refer to any kind of shared entities to provide services, and may include computing or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with or equivalent to “communications channel,” “data communications channel,” “transmission channel,” “data transmission channel,” “access channel,” “data access channel,” “link,” “data link,” “carrier,” “radio-frequency carrier,” or any other like term denoting a pathway or medium through which data is communicated. Additionally, the term “link” as used herein refers to a connection between two devices for the purpose of transmitting and receiving information.

The terms “instantiate,” “instantiation,” and the like as used herein refers to the creation of an instance. An “instance” also refers to a concrete occurrence of an object, which may occur, for example, during execution of program code.

The term “connected” may mean that two or more elements, at a common communication protocol layer, have an established signaling relationship with one another over a communication channel, link, interface, or reference point.

The term “network element” as used herein refers to physical or virtualized equipment or infrastructure used to provide wired or wireless communication network services. The term “network element” may be considered synonymous to or referred to as a networked computer, networking hardware, network equipment, network node, or a virtualized network function.

The term “information element” refers to a structural element containing one or more fields. The term “field” refers to individual contents of an information element, or a data element that contains content. An information element may include one or more additional information elements.

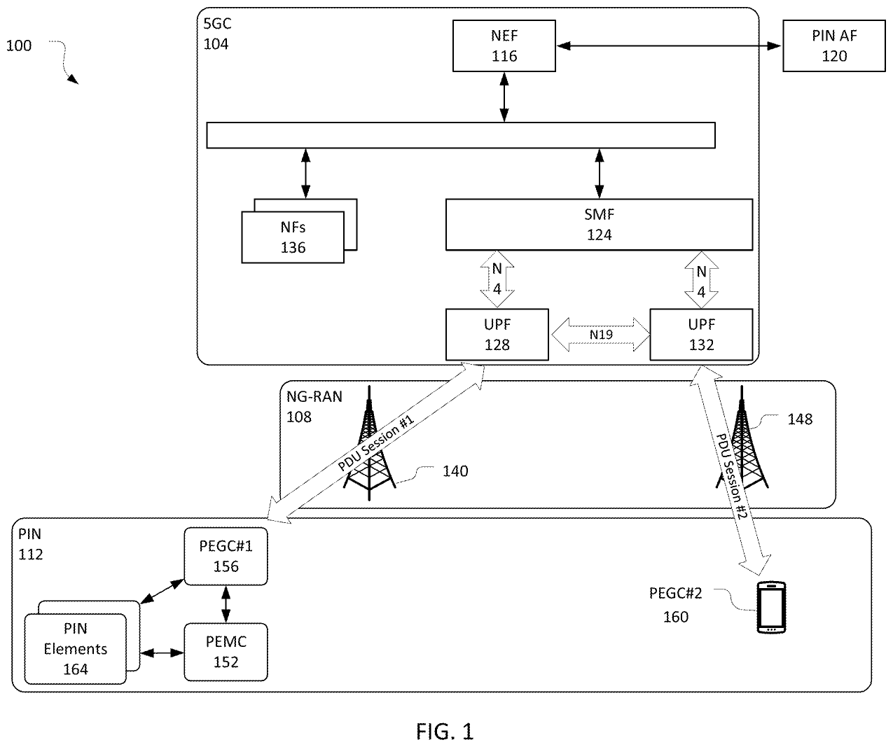

FIG. 1 illustrates a network environment 100 in accordance with some embodiments. The network environment 100 may include various components of a core network (CN) (for example, a 5G core network (5GC) 104), a radio access network (RAN) (for example, next generation RAN (NG-RAN) 108), and a PIN 112. In some embodiments, the 5GC 104 and the NG-RAN 108 may be referred to as a 5G system (5GS). In other embodiments, the network environment 100 may additionally/alternatively be compatible with other network generations including, for example, fourth generation (4G) or sixth generation (6G) networks.

The 5GC 104 may have a variety of network functions that provide services such as storing subscription information, authenticating user equipments (UEs)/network components, registering and tracking UEs, managing quality of service (QOS) aspects, controlling data sessions, and forwarding uplink/downlink traffic.

The 5GC 104 may have a network exposure function (NEF) 116 to provide information related to the capabilities of the network functions of the 5GC 104 to external network functions such as, for example, PIN AF 120. The PIN AF 120, which may also be referred to as a PIN management function (MF), may provide support for services associated with communications related to PINs, for example, PIN 112. The PIN AF 120 may be provided by an application server (AS) in an external data network. Alternatively, the PIN AF 120 may provide control-plane signaling for control signaling, while a PIN AS provides user-plane signaling for application data. In some embodiments, the PIN AF 120 may have not have direct access to other network functions of the 5GC 104 and may, therefore, be coupled with the NEF 116. In other embodiments, the PIN AF 120 may have direct access and may be coupled with a policy control function (PCF) of the 5GC 104 through an N5 reference point. A “reference point” may refer to a point-to-point interface that may be associated with a prescribed set of signaling procedures between the coupled functions. A “reference point” may be used interchangeably with an “interface” throughout the disclosure.

The 5GC 104 may also have a session management function (SMF) 124. The SMF 124 may configure traffic steering, QoS control and policy related functions at one or more user plane functions (UPF) (such as UPF 128 and 132), perform protocol data unit (PDU) session management, Internet protocol (IP) address allocation, general packet radio service tunneling protocol-user plane (GTP-U) tunnel management, selection and control of UPFs, and downlink notification management. The SMF 124 may be coupled with the UPFs 128 and 132 via N4 interfaces.

The UPFs 128/132 may handle the user plane path of PDU sessions to facilitate routing of traffic to and from an external data network and within the network environment 100 as described herein.

The 5GC 104 may have a number of additional network functions (NFs) 136 not specifically shown or described. These NFs may include, but are not limited to, a PCF, unified data manager (UDM), and an access and mobility management function (AMF).

The NG-RAN 108 may include base stations (for example, base stations 140 and 148) that provide wireless access cells, for example, new radio (NR) cells, through which user equipments (UEs) may access services of the network environment 100. The UEs and the base stations 140/148 may communicate over air interfaces compatible with 5G NR system standards as provided by 3GPP technical specifications.

The PIN 112 may be a collection of PIN elements (PINEs), for example, IoT elements and UEs, that may be directly coupled with one another. The PIN 112 may be set up with the help of components of the 5GC 104. The PIN 112 may be a smart home network, a wearable personal area network, etc.

The elements of the PIN 112 may communicate with each other using short-range communication protocols such as, for example, 3GPP PC5 Sidelink, wireless local area network (WLAN) protocols, and wireless personal area network (WPAN) protocols.

The PIN 112 may include certain types of elements that are configured to provide specific functions for the PIN 112. For example, the PIN 112 may include a PIN element with management capability (PEMC) 152 and one or PIN elements with gateway capability (PEGCs) (for example, PEGC#1 156 and PEGC#2 160). The PEMC 152, PEGC#1 156, and PEGC#2 160 may be UEs capable of accessing the NG-RAN 108 and 5GC 104. The PIN 112 may also include a number of other PIN elements 164.

The PEMC 152 may manage the setup and operation of the PIN 112 with the help of components of the 5GC 104. The PEGCs may operate as an interface between the PIN 112 and the NG-RAN 108. The PEGCs 156/160 may be enabled with independent connectivity toward 5GC 104. If the PEGC#2 160 is within range of the other elements of the PIN 112, it may connect with the 5GC 104 using its own connectivity option or through the PEGC#1 156. In some embodiments, one UE may serve as both a PEMC and a PEGC.

The short-range communication protocols used for communications among the elements of PIN 112 may be useful when the communicating elements are within proximity of one another. However, in scenarios in which the PIN 112 includes more than one PEGC and one of the PEGCs is not in proximity with the other elements of the PIN 112, communication paths may traverse through other networks. Securing the communication paths as they traverse through other networks may be desired in a number of scenarios.

Consider, for example, a first scenario in which a user of a smartphone may wish to access a camera while the smartphone is outside of direct communication range with the camera. In a conventional system, both the smartphone and the camera would utilize connections with an application server (either from a manufacturer or an IOT network provider) that is within a data network external to a 5GS. A 5GS would route data over N6 interfaces between UPFs and an external data network. An application server of the external data network would then provide the required connection setup.

Another scenario may relate to a PIN having a voice-activated smart-home assistant. Such a smart-home assistant may have a distributed architecture in which different processing operations are performed within different PIN elements. If a smart-home assistant instance in a smartphone needs access to a smart-home assistant instance in a PIN element that is not in direct communication with the smart phone, the connections may need to traverse external networks similar to that described above.

Translating the above scenarios into the network environment 100, an element of a first part of the PIN 112 (for example, a first element of the PIN elements 164) may need to communicate with an element of a second part of the PIN 112 (for example, the PEGC#2 160) when the elements are not in direct communication range with one another (or another PIN element that may act as a relay).

Embodiments describe the network environment 100 configured to provide internal routing between PDU sessions used by PEGCs (for example, PEGC#1 156 and PEGC#2 160) of the same PIN (for example, PIN 112). With the internal routing, the communication path between PEGC#1 156 and PEGC#2 160 may stay within the secure 5GS and does not need to traverse an N6 interface to an external data network. Various embodiments describe setting up and using the communication path between elements of the PIN 112 via the 5GS.

When the PIN 112 is set up within the network environment 100, provision may be made for routing PIN communication within the secure domain provided by the 5GS without having to route communication via an external data network. Routing PIN communication within the 5GS without using an N6 interface to an external data network may be referred to herein as local routing.

In some embodiments, PEGC#1 156 and PEGC#2 160 may have PDU sessions terminated in a common UPF. In these embodiments, the communication path within the PIN 112 via 5GS may be realized using 5GC procedures for local switching within the UPF. In other embodiments, PEGC#1 156 and PEGC#2 160 may have PDU sessions anchored by different UPFs (for example, PDU session #1 anchored by UPF 128 and PDU session #2 anchored by UPF 132 as shown in FIG. 1). In these embodiments, the communication path within the PIN 112 via 5GS may be realized using an N19 interface between UPFs 128 and 132. Thus, various embodiments may authorize a PIN 112 for local routing using PEGCs connected to the same UPF or using N19 interface between a plurality of UPFs. In some embodiments, the local routing may be restricted to PEGCs connected with UPFs that are within the same SMF service area (for example, the UPFs are coupled with the same SMF).

In some embodiments, the PIN 112 may be configured for local routing within specific geographical areas. For example, the PIN 112 may be configured for local routing when PEGC#1 156 and PEGC#2 160 are connecting with the 5GC 104 through specific NG-RANs (for example, NG-RAN 108) or base stations.

In some embodiments, the PIN 112 may be configured for local routing within specific time periods. For example, the PIN 112 may be configured for local routing for time periods deemed more critical for secure intra-5GC routing.

A granular identification of PDUs for local routing may be performed by configuring packet filters sets. A packet filter set may be identified by using an IP 5-tuple, for example. An IP 5-tuple may include a source IP address, a source port, a destination IP address, a destination port, and a transport protocol. In some instances, this may be used to provide certain PIN elements with the privilege for local routing services. For example, the PIN 112 may be configured in a manner that some PIN elements may utilize local routing, while others may not. This may be used to provide a first PIN element that transmits/receives more sensitive information, for example, video, with the more secure local routing option, while a second PIN element that transmits/receives less sensitive information, for example, sensed temperature settings, with the standard routing option that involves the external data network.

Embodiments may apply for the PIN 112 having more than one PEGC authorized to communicate with the 5GC 104. While embodiments describe local routing of communications between two PEGCs of the PIN 112; other embodiments may apply to local routing of communications between more than two PEGCs of the PIN 112.

The PIN AF 120 may use an external parameter provisioning interface to provide local switching or 5GS routing configurations for the PIN traffic. In some embodiments, the PIN AF 120 may provide the following configuration parameters to facilitate the local routing of PIN traffic.

The configuration parameters may include a data network name (DNN) that identifies a data network that includes the external PIN application server that provides services for the PIN 112.

The configuration parameters may additionally/alternatively include single network slice selection assistance information (S-NSSAI) to identify a network slice that provides services for the PIN 112.

The configuration parameters may additionally/alternatively include a PIN identifier to identify the PIN 112.

The configuration parameters may additionally/alternatively include PIN element identifiers for which local routing support is to be provided. The PIN element identifiers may be IP addresses or general public subscription identifiers (GPSIs) that identify the elements of the PIN 112. If the PEGCs of the PIN 112 provide network address translations (NAT) for the PIN elements, the PIN AF 120 may only configure IP addresses of the PEGCs. In some embodiments, the PIN element identifiers may include identifiers associated with PIN elements behind a PEGC (for example, PIN elements 164 behind PEGC#1 156) using framed routing in a PDU session. Framed routing may support an IP network behind a UE in a manner that allows a range of IPv4 addresses or IPv6 prefixes to be reachable over a single PDU session. Thus, one PDU session may be associated with a plurality of framed routes. Framed routing may be similar to that described in clause 5.6.14 of TS 23.501 v17.4.0 (2022-03-23).

In some embodiments, the PIN AF 120 may only authorize a subset of PEGCs of the PIN 112 for local routing. Consider, for example, that PIN 112 included a third PEGC (PEGC#3). The PIN AF 120 may authorize PEGC#1 156 and PEGC#2 for local routing by including respective PIN element identifiers in the configuration parameters. If the PIN element identifier of PEGC#3 is not included, that PEGC may not be authorized for local routing.

The configuration parameters may additionally/alternatively include any restrictions for local routing. For example, in some embodiments, local routing may be restricted to specific geographical locations in the PIN AF 120 may provide an indication of these locations in which a PEGC may opt for local routing. The geographical restrictions may be associated with network equipment that provides connection services for the PEGCs. For example, some geographical restrictions may be applied by indicating a set of base stations/NG-RANs that may be used to support local routing. In another example, a geographical restriction may be applied by indicating one UPF or a set of specific UPFs (if N19 based routing is allowed) that may be used to support local routing. In some embodiments, local routing may be subject to time restrictions.

The configuration parameters may additionally/alternatively include traffic characteristics for local routing. The traffic characteristics may include a packet filter set that may be used by the UPFs 128/132 to identify traffic that is to be locally routed. The packet filter set may include, for example, an IP 5-tuple, that allows for granular routing of traffic.

The PIN AF 120 may provide the configuration parameters to the SMF 124 via the NEF 116. The SMF 124 may use the configuration parameters to identify the associated PDU sessions to be configured to support local routing. When all the PEGCs have PDU sessions in a common UPF, local switching within the UPF may be used. If PEGCs have PDU sessions established with different UPFs, as shown in FIG. 1, the SMF 124 may create a group-level N4 session. For example, the SMF 124 may configure UPF 128, which anchors PDU session #1 for PEGC#1 156, and UPF 132, which anchors PDU session #2 for

PEGC#2 160, with group-level N4 rules based on the configuration parameters. The group-level N4 rules may use the PIN identifier as a network instance. The UPFs 128/132 may use the group-level N4 rules to setup a PIN-specific tunnel over the N19 interface for local routing.

In some embodiments, local routing may only be supported when all the UPFs are in the same SMF service area. This may ensure that one SMF is able to create/manage the group-level N4 session.

When a PDU session is established or modified for a PEGC of a PIN configured for local routing, the SMF 124 may evaluate whether the conditions for installing UPF rules for local routing are met. If the conditions are met, the SMF 124 may configure the UPF(s) with routing rules as described as follows.

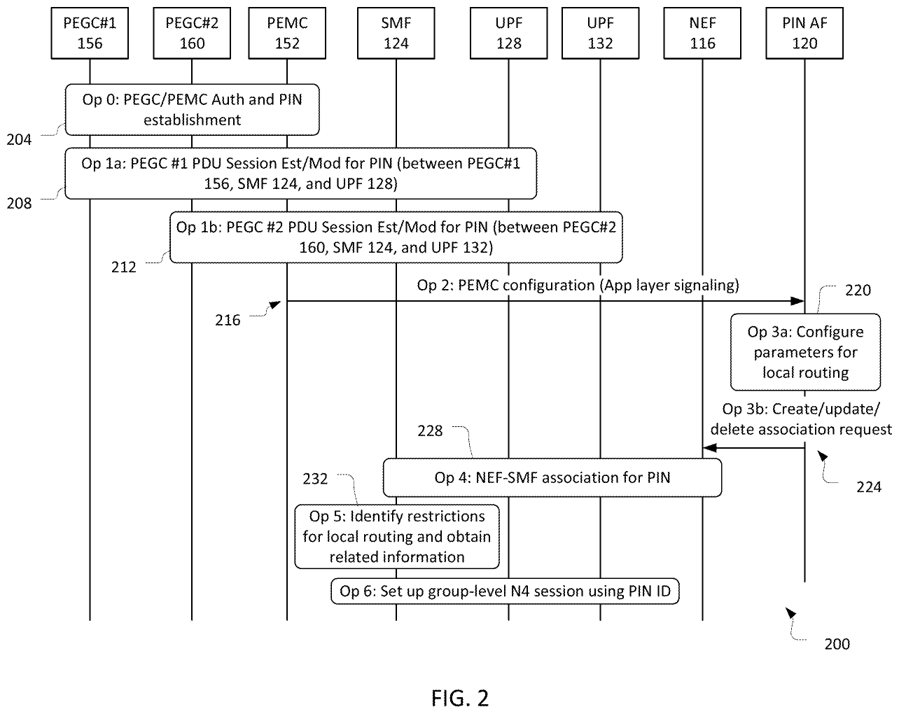

FIG. 2 is a flow diagram 200 that illustrates configuration of local routing for PEGC#1 156 and PEGC#2 160 of PIN 112 in accordance with some embodiments.

The flow diagram 200 may include, at 204, operation 0 (Op 0) in which the PIN 112 is created. The PIN 112 may be provisioned with one or more PEGCs. As shown in FIG. 1, the PIN 112 may be provisioned with two PEGCs, PEGC#1 156 and PEGC#2 160. However, in other embodiments, the PIN 112 may be provisioned with more than two PEGCs. Operation 0 may additionally include provisioning the PIN 112 with PEMC 152. The provisioning of the PEGCs/PEMC may also include authorizing the PIN elements for operation in their respective roles.

In some embodiments, the provisioning of the PEGCs/PEMC may include a number of operations related to the discovery, selection, authentication, and registration of the PIN elements. Some of these operations may be done locally, for example, based on operations between the devices of the PIN 112, while other operations may include communication with the PIN AF 120 or a PIN application server in an external data network.

The flow diagram 200 may further include, at 208, operation 1a (Op 1a) in which the PEGC#1 156 establishes or modifies PDU session #1 for the PIN 112. Operation la may include signaling between PEGC#1 156, SMF 124, and UPF 128.

The flow diagram 200 may further include, at 212, operation 1b (Op 1b) in which the PEGC#2 160 establishes or modifies PDU session #2 for the PIN 112. Operation 1b may include signaling between PEGC#2 160, SMF 124, and UPF 132.

The flow diagram 200 may further include, at 216, operation 2 (Op 2) in which the PEMC 152 provides the PIN AF 120 with a PEMC configuration. Operation 2 may include application layer signaling of the PEMC configuration. The PMC configuration may include the IP addresses of the PEGC#1 156 and PEGC#2 160. If framed routing is used, the PINE identifiers that may use local routing may also be provided to the PIN AF 120.

The flow diagram 200 may further include, at 220, operation 3a (Op 3a) in which the PIN AF 120 configures parameters for local routing. The configuration parameters for local routing may be similar to those discussed above and elsewhere herein. In some embodiments, additional configuration parameters for PIN communications may also be configured. For example, the additional configuration parameters may include information on whether some PIN elements are allowed/disallowed to access the Internet, a specific Internet service, or other PIN elements.

The flow diagram 200 may further include, at 224, operation 3b (Op 3b) in which the PIN AF 120 provides the configured parameters to the NEF 116 in an association request. The message at 224 may be a create, update, or delete association request message. The NEF 116 may the proceed to authorize the request.

The flow diagram 200 may further include, at 228, operation 4 (Op 4) in which the NEF 116, upon authorizing the request received in operation 3b, may create an NEF-SMF association for PIN management. In some embodiments, the NEF-SMF association may be established in a manner similar to that described in clause 6.12.2.1 of 3GPP Technical Report (TR) 23.700-88 v.0.2.0 (2022-04). In some instances, an “NEF ID for PIN” may be used to establish the NEF-SMF association as discussed in clause 6.12.2.1 of TR 23.700-88. In other instances, a separate ID, for example, “NEF ID for local routing for PIN” may be used instead. In establishing the NEF-SMF association, the NEF 116 may also provide the SMF 124 with the configuration parameters received from the PIN AF 120 to allow the SMF 124 to create N4 rules for local routing.

The flow diagram 200 may further include, at 232, operation 5 (Op 5) in which the SMF 124 identifies restrictions within the configuration parameters and acquires related information. For example, in the event the restrictions include a geographical restriction based on a set of one or more NG-RANs being authorized for local routing, the SMF 124 may obtain the NG-RAN identifiers for the relevant NG-RANs.

The flow diagram 200 may further include, at 236, operation 6 (Op 6) in which the SMF 124 sets up a group-level N4 session using the PIN ID. To set up the group-level N4 session, the SMF 124 may create N4 rules based on the configuration parameters (and any related information obtained in operation 5). Except as otherwise described herein and as follows, the N4 rules may be created in a manner similar to that described in clause 5.8.2.13 of 3GPP TS 23.501.

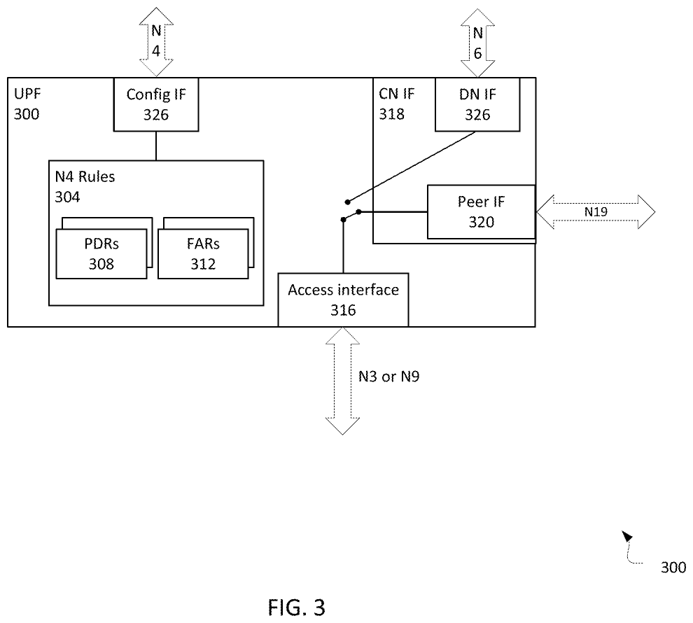

FIG. 3 illustrates a UPF 300 configured for internal routing of PIN communications in accordance with some embodiments. The UPF 300 may be similar to, and substantially interchangeable with UPF 128 or UPF 132.

The UPF 300 may be configured with local routing rules (for example, N4 rules 304) through a configuration interface 306 coupled with an N4 reference point. The N4 rules may include packet detection rules (PDRs) 308 and forward action rules (FARs) 312. The UPF 300 may use these rules to identify and forward traffic in between a plurality of interfaces. The interfaces may include an access interface 316, coupled with the N3 reference point or an N9 reference point, and a plurality of CN interfaces 318. The CN interfaces 318 may include a peer interface 320, coupled with the N19 reference point, and a data network (DN) interface, coupled with an N6 reference point.

The N4 rules 304 may include the following detection and forwarding rules configured for processing packets arriving from a PEGC having a PDU session anchored at the UPF 300. In order to detect the traffic, the N4 rules 304 may include a PDR containing a source interface set to “access side,” and CN tunnel information set to PDU session tunnel header (for example, N3 or N9 general packet radio service tunneling protocol-user (GTP-U) fully qualified tunnel identifier (F-TEID)) that is associated with the PDU session anchored at the UPF 300. In order to forward the traffic, the N4 rules may include an FAR containing a destination interface set to “5G PIN internal” +PIN identifier. “5G PIN internal” may be used herein to identify an internal PIN interface. In other embodiments, other names may be used to identify such an interface. Local routing may then be applied to traffic received from the PEGC that includes packets that match the PDR/FAR.

The N4 rules 304 may include the following detection and forwarding rules configured for processing packets towards a PEGC having a PDU session anchored at the UPF 300. In order to detect the traffic, the N4 rules 304 may include a PDR containing a source interface set to “5G PIN internal” +PIN identifier, and destination address set to the IP address(es) of this PEGC/PIN elements (IP addresses configured for framed routing if that is used). In order to forward the traffic, the N4 rules 304 may include an FAR containing outer header creation indicating the N3/N9 tunnel information, and destination interface set “access side.”

If N19-based forwarding is to be used, the SMF 124 may configure the group-level N4 session for each N19 tunnel by providing the N4 rules 304 as follows.

For processing packets received from a N19 tunnel, the N4 rules 304 may include the following detection and forwarding rules. In order to detect the traffic, the N4 rules 304 may include a PDR containing source interface set to “core side,” and CN tunnel information set to N19 tunnel header (for example, N19 GTP-U F-TEID). In order to forward the traffic, the N4 rules may include a FAR containing a destination interface set to “5G PIN internal” +PIN identifier.

For processing packets towards a 5G PIN Gateway/Element anchored at another UPF, the N4 rules 304 may include the following detection and forwarding rules. In order to detect the traffic, the N4 rules 304 may include a PDR containing a source interface set to “5G PIN internal” +PIN identifier, and a destination address set to the IP address(es) of PEGCs/PIN Elements anchored at the peer UPF of this N19 tunnel. In order to forward the traffic to a 5G PIN Gateway/Element anchored at another UPF via the N19 tunnel, the N4 rules may include a FAR containing outer header creation indicating the N19 tunnel information and a destination interface set to “core side.”

In some embodiments, the SMF 124 may also configure the N4 rules 304 for the group-level N4 Session in a manner that will allow the UPF 300 to process packets with an unknown destination address as follows. In order to detect the traffic, the N4 rules 304 may include a PDR containing source interface set to “5G PIN internal” +PIN identifier, a match-all packet filter, and a precedence set to a lowest precedence value. In order to process the traffic, the N4 rules 304 may include a FAR containing destination interface set to “core side” to route the traffic via N6 by default, or in the case of local SMF configuration that N6-based forwarding is not applied a FAR instructing the UPF to drop the traffic.

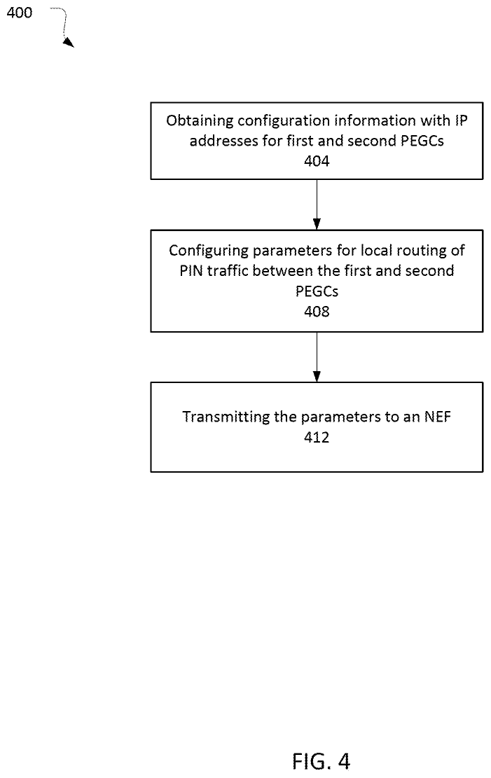

FIG. 4 is an operation flow/algorithmic structure 400 in accordance with some embodiments. The operation flow/algorithmic structure 400 may be implemented by PIN AF 120 or network node 800 of FIG. 8; or components thereof such as processors 804.

The operation flow/algorithmic structure 400 may include, at 404, obtaining configuration information that includes IP addresses for a plurality of PEGCs of a PIN. The configuration information may be received by application layer signaling from a PEMC of the PIN. In some embodiments, the configuration information made include addresses for one or more PIN elements in addition to the PEGCs.

The operation flow/algorithmic structure 400 may further include, at 408, configuring parameters for local routing of PIN traffic between the first PEGC and the second PEGC. The parameters may include a DNN or S-NSSAI. In some embodiments, the parameters may include a PDU session type that may be associated with PDU sessions of the plurality of PEGCs.

The configured parameters may also include a PIN identifier to identify the PIN for which local routing is to be configured, and PIN element identifiers that are associated with the PIN elements that may engage in the local routing. The PIN element identifiers may be IP addresses or GPSIs.

In some embodiments, the configured parameters may include restrictions that may be imposed on local routing for the PIN. The restrictions may include geographical or time-based restrictions.

The operation flow/algorithmic structure 400 may further include, at 412, transmitting the parameters to an NEF in an association request. The association request may be a create, update, or delete association request.

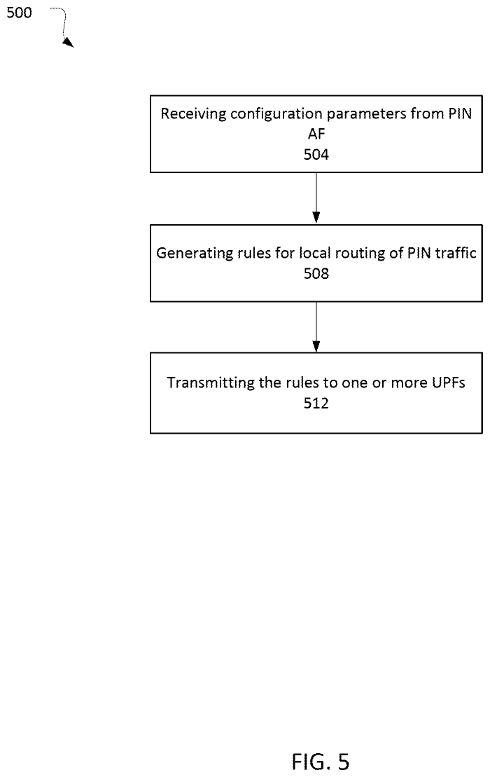

FIG. 5 is an operational flow/algorithmic structure 500 in accordance with some embodiments. The operation flow/algorithmic structure 500 may be implemented by SMF 124 or network node of FIG. 8 or components thereof such as processors 804.

The operation flow/algorithmic structure 500 may include, at 504, receiving configuration parameters from a PIN AF. The configuration parameters may be received via an NEF as part of establishing a NEF-SMF association for a PIN. The configuration parameters may be similar to those described above with respect to FIG. 4 or elsewhere herein.

The operation flow/algorithmic structure 500 may further include, at 508, generating rules for local routing of PIN traffic. The rules may be UPF rules, which may also be referred to as N4 rules, that may be used to detect and forward traffic over appropriate local routing communication paths. The rules may be used to set up a group-level N4 session using the PIN identifier.

The operation flow/algorithmic structure 500 may further include, at 512, transmitting the rules to one or more UPFs.

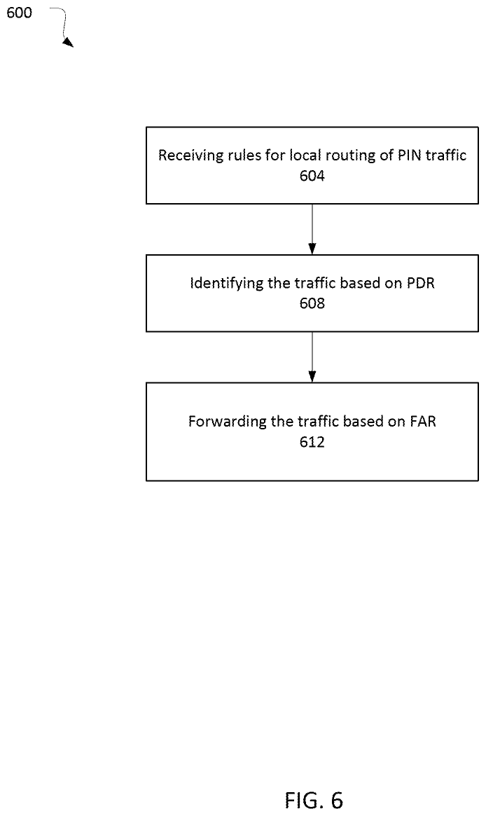

FIG. 6 is an operational flow/algorithmic structure 600 in accordance with some embodiments. The operation flow/algorithmic structure 600 may be implemented by UPF 128, UPF 132, UPF 300 or network node of FIG. 8 or components thereof such as processors 804.

The operation flow/algorithmic structure 600 may include, at 604, receiving rules for local routing of PIN traffic. The rules may be UPF/N4 rules similar to those discussed above with respect to FIG. 5 or elsewhere herein. The rules may include PDRs and FARs.

The operation flow/algorithmic structure 600 may further include, at 608, identifying traffic based on a PDR of the rules. Some specific PDRs are discussed below.

If the UPF anchors a PDU session for a first PEGC from which PIN traffic for local routing is received, the PDR may have a source interface set to access side and core network tunnel information set to a PDU session tunnel header associated with the PDU session.

If the UPF anchors a PDU session for the first PEGC and the traffic for local routing is directed towards the first PEGC, the PDR may have a source interface set to a value of “5G PIN internal” plus a PIN identifier, and a destination address set to an IP address of the first PEGC or a PIN element associated with the first PEGC.

If the UPF is coupled with another UPF via an N19 tunnel and the traffic for local routing is from the N19 tunnel, the PDR may have a source interface set to a core side and core network tunnel information set to the header of the N19 tunnel.

If the UPF is coupled with another UPF via an N19 tunnel and the traffic for local routing is directed towards a first PEGC anchored by the other UPF, the PDR may have a source interface set to a PIN internal value plus a PIN identifier and a destination address set to an IP address of the first PEGC or PIN element associated with the first PEGC.

The operation flow/algorithmic structure 600 may further include, at 612, forwarding the traffic based on a FAR of the rules. Some specific FARs are discussed below.

If the UPF anchors a PDU session for a first PEGC from which PIN traffic for local routing is received, the FAR may have a destination interface set to a PIN internal value plus a PIN identifier.

If the UPF anchors a PDU session for the first PEGC and the traffic for local routing is directed towards the first PEGC, the FAR may have an outer header creation to indicate tunnel information and a destination interface set to access side.

If the UPF is coupled with another UPF via an N19 tunnel and the traffic for local routing is from the N19 tunnel, the FAR may have a destination interface set to a PIN internal value plus a PIN identifier.

If the UPF is coupled with another UPF via an N19 tunnel and the traffic for local routing is directed towards a first PEGC anchored by the other UPF, the FAR may have an outer header creation that indicates tunnel information of the N19 tunnel and a destination interface set to core side.

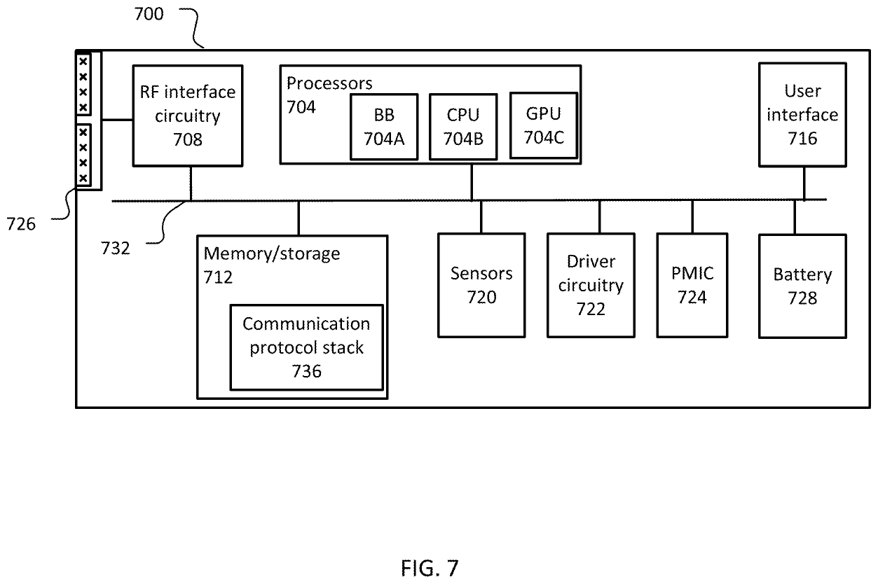

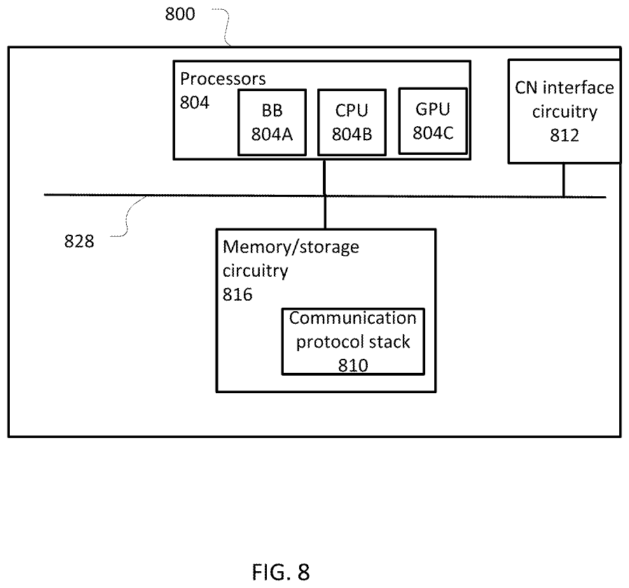

FIG. 7 illustrates an example PIN element 700 in accordance with some embodiments. The PIN element 700 may be any mobile or non-mobile computing device, such as, for example, mobile phones, computers, tablets, industrial wireless sensors (for example, microphones, carbon dioxide sensors, pressure sensors, humidity sensors, thermometers, motion sensors, accelerometers, laser scanners, fluid level sensors, inventory sensors, electric voltage/current meters, actuators, etc.), video surveillance/monitoring devices (for example, cameras, video cameras, etc.), wearable devices (for example, a smart watch), relaxed-IoT devices. In some embodiments, the PIN element 700 may be a RedCap UE or NR-Light UE.

The PIN element 700 may include processors 704, RF interface circuitry 708, memory/storage 712, user interface circuitry 716, sensor circuitry 720, driver circuitry 722, power management integrated circuit (PMIC) 724, antenna structure 726, and battery 728. The components of the PIN element 700 may be implemented as integrated circuits (ICs), portions thereof, discrete electronic devices, or other modules, logic, hardware, software, firmware, or a combination thereof. The block diagram of FIG. 7 is intended to show a high-level view of some of the components of the PIN element 700. However, some of the components shown may be omitted, additional components may be present, and different arrangement of the components shown may occur in other implementations.

The components of the PIN element 700 may be coupled with various other components over one or more interconnects 732, which may represent any type of interface, input/output, bus (local, system, or expansion), transmission line, trace, optical connection, etc. that allows various circuit components (on common or different chips or chipsets) to interact with one another.

The processors 704 may include processor circuitry such as, for example, baseband processor circuitry (BB) 704A, central processor unit circuitry (CPU) 704B, and graphics processor unit circuitry (GPU) 704C. The processors 704 may include any type of circuitry or processor circuitry that executes or otherwise operates computer-executable instructions, such as program code, software modules, or functional processes from memory/storage 712 to cause the PIN element 700 to perform operations as described herein.

In some embodiments, the baseband processor circuitry 704A may access a communication protocol stack 736 in the memory/storage 712 to communicate over a 3GPP compatible network. In general, the baseband processor circuitry 704A may access the communication protocol stack to: perform user plane functions at a PHY layer, MAC layer, RLC layer, PDCP layer, SDAP layer, and PDU layer; and perform control plane functions at a PHY layer, MAC layer, RLC layer, PDCP layer, RRC layer, and a non-access stratum layer. In some embodiments, the PHY layer operations may additionally/alternatively be performed by the components of the RF interface circuitry 708.

The baseband processor circuitry 704A may generate or process baseband signals or waveforms that carry information in 3GPP-compatible networks. In some embodiments, the waveforms for NR may be based cyclic prefix OFDM (CP-OFDM) in the uplink or downlink, and discrete Fourier transform spread OFDM (DFT-S-OFDM) in the uplink.

The memory/storage 712 may include one or more non-transitory, computer-readable media that includes instructions (for example, communication protocol stack 736) that may be executed by one or more of the processors 704 to cause the PIN element 700 to perform various operations described herein. The memory/storage 712 include any type of volatile or non-volatile memory that may be distributed throughout the PIN element 700. In some embodiments, some of the memory/storage 712 may be located on the processors 704 themselves (for example, L1 and L2 cache), while other memory/storage 712 is external to the processors 704 but accessible thereto via a memory interface. The memory/storage 712 may include any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 708 may include transceiver circuitry and radio frequency front module (RFEM) that allows the PIN element 700 to communicate with other devices over a radio access network. The RF interface circuitry 708 may include various elements arranged in transmit or receive paths. These elements may include, for example, switches, mixers, amplifiers, filters, synthesizer circuitry, control circuitry, etc.

In the receive path, the RFEM may receive a radiated signal from an air interface via antenna structure 726 and proceed to filter and amplify (with a low-noise amplifier) the signal. The signal may be provided to a receiver of the transceiver that down-converts the RF signal into a baseband signal that is provided to the baseband processor of the processors 704.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna structure 726.

In various embodiments, the RF interface circuitry 708 may be configured to transmit/receive signals in a manner compatible with NR access technologies.

The antenna structure 726 may include antenna elements to convert electrical signals into radio waves to travel through the air and to convert received radio waves into electrical signals. The antenna elements may be arranged into one or more antenna panels. The antenna structure 726 may have antenna panels that are omnidirectional, directional, or a combination thereof to enable beamforming and multiple-input, multiple-output communications. The antenna structure 726 may include microstrip antennas, printed antennas fabricated on the surface of one or more printed circuit boards, patch antennas, phased array antennas, etc. The antenna structure 726 may have one or more panels designed for specific frequency bands including bands in FR1 or FR2.

The user interface circuitry 716 includes various input/output (I/O) devices designed to enable user interaction with the PIN element 700. The user interface circuitry 716 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes “LEDs” and multi-character visual outputs, or more complex outputs such as display devices or touchscreens (for example, liquid crystal displays (LCDs), LED displays, quantum dot displays, projectors, etc.), with the output of characters, graphics, multimedia objects, and the like being generated or produced from the operation of the PIN element 700.

The sensor circuitry 720 may include devices, modules, or subsystems whose purpose is to detect events or changes in its environment and send the information (sensor data) about the detected events to some other device, module, subsystem, etc. Examples of such sensors include, inter alia, inertia measurement units comprising accelerometers, gyroscopes, or magnetometers; microelectromechanical systems or nanoelectromechanical systems comprising 3-axis accelerometers, 3-axis gyroscopes, or magnetometers; level sensors; flow sensors; temperature sensors (for example, thermistors); pressure sensors; barometric pressure sensors; gravimeters; altimeters; image capture devices (for example, cameras or lensless apertures); light detection and ranging sensors; proximity sensors (for example, infrared radiation detector and the like); depth sensors; ambient light sensors; ultrasonic transceivers; microphones or other like audio capture devices; etc.

The driver circuitry 722 may include software and hardware elements that operate to control particular devices that are embedded in the PIN element 700, attached to the PIN element 700, or otherwise communicatively coupled with the PIN element 700. The driver circuitry 722 may include individual drivers allowing other components to interact with or control various input/output (I/O) devices that may be present within, or connected to, the PIN element 700. For example, driver circuitry 722 may include a display driver to control and allow access to a display device, a touchscreen driver to control and allow access to a touchscreen interface, sensor drivers to obtain sensor readings of sensor circuitry 720 and control and allow access to sensor circuitry 720, drivers to obtain actuator positions of electro-mechanic components or control and allow access to the electro-mechanic components, a camera driver to control and allow access to an embedded image capture device, audio drivers to control and allow access to one or more audio devices.

The PMIC 724 may manage power provided to various components of the PIN element 700. In particular, with respect to the processors 704, the PMIC 724 may control power-source selection, voltage scaling, battery charging, or DC-to-DC conversion.

In some embodiments, the PMIC 724 may control, or otherwise be part of, various power saving mechanisms of the PIN element 700. For example, if the platform UE is in an RRC_Connected state, where it is still connected to the RAN node as it expects to receive traffic shortly, then it may enter a state known as Discontinuous Reception Mode (DRX) after a period of inactivity. During this state, the PIN element 700 may power down for brief intervals of time and thus save power. If there is no data traffic activity for an extended period of time, then the PIN element 700 may transition off to an RRC_Idle state, where it disconnects from the network and does not perform operations such as channel quality feedback, handover, etc. The PIN element 700 goes into a very low power state and it performs paging where again it periodically wakes up to listen to the network and then powers down again. The PIN element 700 may not receive data in this state; in order to receive data, it must transition back to RRC_Connected state. An additional power saving mode may allow a device to be unavailable to the network for periods longer than a paging interval (ranging from seconds to a few hours). During this time, the device is totally unreachable to the network and may power down completely. Any data sent during this time incurs a large delay and it is assumed the delay is acceptable.

A battery 728 may power the PIN element 700, although in some examples the PIN element 700 may be mounted deployed in a fixed location, and may have a power supply coupled to an electrical grid. The battery 728 may be a lithium ion battery, a metal-air battery, such as a zinc-air battery, an aluminum-air battery, a lithium-air battery, and the like. In some implementations, such as in vehicle-based applications, the battery 728 may be a typical lead-acid automotive battery.

FIG. 8 illustrates a network node 800 in accordance with some embodiments. The network node 800 may include processors 804, CN interface circuitry 812, memory/storage circuitry 816, and antenna structure 826.

The components of the network node 800 may be coupled with various other components over one or more interconnects 828.

The processors 804, memory/storage circuitry 816 (including communication protocol stack 810), and interconnects 828 may be similar to like-named elements shown and described with respect to FIG. 7.

The CN interface circuitry 812 may provide connectivity to devices that implement functions of a core network, for example, 5GC 104, using a 5GC-compatible network interface protocol such as carrier Ethernet protocols, or some other suitable protocol. Network connectivity may be provided to/from the network node 800 via a fiber optic or wireless backhaul. The CN interface circuitry 812 may include one or more dedicated processors or FPGAs to communicate using one or more of the aforementioned protocols. In some implementations, the CN interface circuitry 812 may include multiple controllers to provide connectivity to other networks using the same or different protocols.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, or network element as described above in connection with one or more of the preceding figures may be configured to operate in accordance with one or more of the examples set forth below in the example section.

### Examples

In the following sections, further exemplary embodiments are provided.
Example 1 includes a method of operating a personal Internet of things network (PIN) application function (AF), the method comprising: obtaining, from a PIN element with management capability (PEMC), configuration information that includes Internet protocol (IP) addresses for a first PIN element with gateway capability (PEGC) and a second PEGC; configuring parameters for local routing of PIN traffic between the first PEGC and the second PEGC; and transmitting the parameters to a network exposure function (NEF) in an association request.
Example 2 includes a method of example 1 or some other example herein, wherein the parameters include: a data network name (DNN); single network slice selection assistance information (S-NSSAI); or a protocol data unit (PDU) session type.
Example 3 includes method of example 1 or some other example herein, wherein the parameters include a PIN identifier.
Example 4 includes the method of example 1 or some other example herein, wherein the parameters include a PIN element identifier associated with a PIN element that is to be provided with local routing support, the PIN element identifier to include an IP address of the PIN element or a generic public subscription identifier (GPSI).
Example 5 includes the method of example 4 or some other example herein, wherein the PIN element is the first PEGC or is in direct communication with the first PEGC.
Example 6 includes the method of example 1 or some other example herein, wherein the parameters include an indication of a geographical location in which local routing is supported for the first PEGC and the second PEGC.
Example 7 includes the method of example 1 or some other example herein, wherein the parameters include an indication of a timing restriction applicable to local routing for the first PEGC and the second PEGC.
Example 8 includes the method of example 1 or some other example herein, wherein the parameters include a packet filter set to identify traffic for local routing associated with the first PEGC and the second PEGC.
Example 9 includes the method of operating a session management function (SMF), the method comprising: receiving, from a network exposure function (NEF), configuration parameters from a personal Internet of things network (PIN) application function (AF); generating, based on the AF configuration, rules for local routing of traffic between a first PIN element with gateway capability (PEGC) and a second PEGC; and transmitting the rules to one or more user plane functions (UPFs).
Example 10 includes the method of example 9 or some other example herein, wherein the configuration parameters include: include a PIN identifier.
Example 11 includes the method of example 10 or some other example herein, further comprising: transmitting the rules to one or more UPFs to set up a group-level N4 session using the PIN identifier.
Example 12 includes the method of example 9 or some other example herein, wherein the configuration parameters include a PIN element identifier associated with a PIN element that is to be provided with local routing support, the PIN element identifier to include an IP address of the PIN element or a generic public subscription identifier (GPSI).
Example 13 includes the method of example 9 or some other example herein, wherein the PIN element is the first PEGC or is in direct communication with the first PEGC.
Example 14 includes the method of example 9 or some other example herein, wherein the configuration parameters include an indication of a geographical location in which local routing is supported for the first PEGC and the second PEGC.
Example 15 includes the method of example 9 or some other example herein, wherein the parameters include an indication of a timing restriction applicable to local routing for the first PEGC and the second PEGC.
Example 16 includes a method of operating a user plane function (UPF), the method comprising: receiving, from a session management function (SMF), rules for local routing of traffic between a first personal Internet of things network (PIN) element with gateway capability (PEGC) and a second PEGC of a PIN, wherein the rules include a packet detection rule (PDR) and a forward action rule (FAR); identifying the traffic based on the PDR; and forwarding the traffic based on the FAR.
Example 17 includes the method of example 16 or some other example herein, wherein: the UPF anchors a protocol data unit (PDU) session for the first PEGC; the traffic is from the first PEGC; the PDR has a source interface set to access side and core network tunnel information set to a protocol data unit (PDU) session tunnel header associated with the PDU session; and the FAR has a destination interface set to a PIN internal value plus an identifier associated with the PIN.
Example 18 includes the method of example 16 or some other example herein, wherein: the UPF anchors a protocol data unit (PDU) session for the first PEGC; the traffic is toward the first PEGC; the PDR has a source interface set to a value of a an internal PIN interface plus an identifier associated with the PIN, and a destination address set to the IP address the first PEGC or a PIN element associated with the first PEGC; and the FAR has an outer header creation to indicate tunnel information and a destination interface set to access side.
Example 19 includes the method of example 17 or some other example herein, wherein: the UPF is a first UPF; the first UPF is coupled with a second UPF via an N19 tunnel; the traffic is from the N19 tunnel; the PDR has a source interface set to a core side and core network tunnel information set to N19 tunnel header associated with the N19 tunnel; and the FAR has a destination interface set to a value of an internal PIN interface plus an identifier associated with the PIN.
Example 20 includes the method of example 16 or some other example herein, further comprising: the UPF is a first UPF; the first UPF is coupled with a second UPF via an N19 tunnel; the traffic is toward the first PEGC, which is anchored by the second UPF; the PDR has a source interface set to a value of an internal PIN interface plus an identifier associated with the PIN and a destination address set to an IP address of the first PEGC or a PIN element associated with the first PEGC; and the FAR has an outer header creation that indicates tunnel information of the N19 tunnel and a destination interface set to core side.
Example 21 may include an apparatus comprising means to perform one or more elements of a method described in or related to any of examples 1-20, or any other method or process described herein.
Example 22 may include one or more non-transitory computer-readable media comprising instructions to cause an electronic device, upon execution of the instructions by one or more processors of the electronic device, to perform one or more elements of a method described in or related to any of examples 1-20, or any other method or process described herein.
Example 23 may include an apparatus comprising logic, modules, or circuitry to perform one or more elements of a method described in or related to any of examples 1-20, or any other method or process described herein.
Example 24 may include a method, technique, or process as described in or related to any of examples 1-20, or portions or parts thereof.
Example 25 may include an apparatus comprising: one or more processors and one or more computer-readable media comprising instructions that, when executed by the one or more processors, cause the one or more processors to perform the method, techniques, or process as described in or related to any of examples 1-20, or portions thereof.
Example 26 may include a signal as described in or related to any of examples 1-20, or portions or parts thereof.
Example 27 may include a datagram, information element, packet, frame, segment, PDU, or message as described in or related to any of examples 1-20, or portions or parts thereof, or otherwise described in the present disclosure.
Example 28 may include a signal encoded with data as described in or related to any of examples 1-20, or portions or parts thereof, or otherwise described in the present disclosure.
Example 29 may include a signal encoded with a datagram, IE, packet, frame, segment, PDU, or message as described in or related to any of examples 1-20, or portions or parts thereof, or otherwise described in the present disclosure.
Example 30 may include an electromagnetic signal carrying computer-readable instructions, wherein execution of the computer-readable instructions by one or more processors is to cause the one or more processors to perform the method, techniques, or process as described in or related to any of examples 1-20, or portions thereof.
Example 31 may include a computer program comprising instructions, wherein execution of the program by a processing element is to cause the processing element to carry out the method, techniques, or process as described in or related to any of examples 1-20, or portions thereof.
Example 32 may include a signal in a wireless network as shown and described herein.
Example 33 may include a method of communicating in a wireless network as shown and described herein.
Example 34 may include a system for providing wireless communication as shown and described herein.
Example 35 may include a device for providing wireless communication as shown and described herein.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

1.-20. (canceled).

21. A method comprising:
obtaining, from a personal Internet of things network (PIN) element with management capability (PEMC), configuration information that includes Internet protocol (IP) addresses for a first PIN element with gateway capability (PEGC) and a second PEGC;
configuring parameters for local routing of PIN traffic between the first PEGC and the second PEGC; and
generating an association request to include the parameters, the association request to be transmitted to a network exposure function (NEF).

22. The method of claim 21, wherein the parameters include: a data network name (DNN); single network slice selection assistance information (S-NSSAI); a protocol data unit (PDU) session type; or a PIN identifier.

23. (canceled)

24. The method of claim 21, wherein the parameters include a PIN element identifier associated with a PIN element that is to be provided with local routing support, the PIN element identifier to include an IP address of the PIN element or a generic public subscription identifier (GPSI).

25. The method of claim 24, wherein the PIN element is the first PEGC or is in direct communication with the first PEGC.

26. The method of claim 21, wherein the parameters include:
an indication of a geographical location in which local routing is supported for the first PEGC and the second PEGC; or an indication of a timing restriction applicable to local routing for the first PEGC and the second PEGC.

27. (canceled)

28. The method of claim 21, wherein the parameters include a packet filter set to identify traffic for local routing associated with the first PEGC and the second PEGC.

29. One or more non-transitory computer-readable media having instructions that, when executed, cause processing circuitry to:
receive, from a network exposure function (NEF), configuration parameters for a personal Internet of things network (PIN);
generate, based on the configuration parameters, rules for local routing of traffic between a first PIN element with gateway capability (PEGC) and a second PEGC via a user plane function (UPF); and
output the rules for transmission to (the UPF).

30. The one or more non-transitory computer-readable media of claim 29, wherein the configuration parameters include a PIN identifier.

31. The one or more non-transitory computer-readable media of claim 30, wherein the instructions, when executed, further cause the processing circuitry to:
encode the rules for transmission to the UPFs to set up a group-level N4 session using the PIN identifier.

32. The one or more non-transitory computer-readable media of claim 29, wherein the configuration parameters include a PIN element identifier associated with a PIN element that is to be provided with local routing support, the PIN element identifier to include an IP address of the PIN element or a generic public subscription identifier (GPSI).

33. The one or more non-transitory computer-readable media of claim 32, wherein the PIN element is the first PEGC or is in direct communication with the first PEGC.

34. The one or more non-transitory computer-readable media of claim 29, wherein the configuration parameters include an indication of a geographical location in which local routing is supported for the first PEGC and the second PEGC.

35. The one or more non-transitory computer-readable media of claim 29, wherein the configuration parameters include an indication of a timing restriction applicable to local routing for the first PEGC and the second PEGC.

36. An apparatus comprising:
processing circuitry to:
receive, from a session management function (SMF), rules for local routing of traffic between a first personal Internet of things network (PIN) element with gateway capability (PEGC) and a second PEGC of a PIN via a user plane function (UPF), wherein the rules include a packet detection rule (PDR) and a forward action rule (FAR);
identify the traffic based on the PDR; and
forward the traffic based on the FAR; and
interface circuitry coupled to the processing circuitry to enable communication.

37. The apparatus of claim 43, wherein:
the traffic is from the first PEGC;
the PDR has a source interface set to access side and core network tunnel information set to a PDU session tunnel header associated with the PDU session; and
the FAR has a destination interface set to a PIN internal value plus an identifier associated with the PIN.

38. The apparatus of claim 43, wherein:
the traffic is toward the first PEGC;
the PDR has a source interface set to a value of an internal PIN interface plus an identifier associated with the PIN, and a destination address set to an Internet protocol (IP) address the first PEGC or a PIN element associated with the first PEGC; and
the FAR has an outer header creation to indicate tunnel information and a destination interface set to access side.

39. The apparatus of claim 36, wherein
the apparatus corresponds to a first UPF that is to be coupled with a second UPF via an N19 tunnel; and
wherein:
the traffic is from the N19 tunnel;
the PDR has a source interface set to a core side and core network tunnel information set to an N19 tunnel header associated with the N19 tunnel; and
the FAR has a destination interface set to a value of an internal PIN interface plus an identifier associated with the PIN; or
wherein:
the traffic is toward the first PEGC, which is anchored by the second UPF;
the PDR has a source interface set to a value of an internal PIN interface plus an identifier associated with the PIN and a destination address set to an IP address of the first PEGC or a PIN element associated with the first PEGC; and
the FAR has an outer header creation that indicates tunnel information of the N19 tunnel and a destination interface set to core side.

40. (canceled)

41. The one or more non-transitory computer-readable media of claim 29, wherein the first PEGC and the second PEGC have respective packet data unit (PDU) sessions associated with the PIN that are terminated with the UPF.

42. The one or more non-transitory computer-readable media of claim 29, wherein the UPF is a first UPF and wherein the local routing of traffic is between the first PEGC and the second PEGC via a plurality of UPFs including the first UPF.

43. The apparatus of claim 36, wherein the UPF is to anchor a first protocol data unit (PDU) session for the first PEGC and a second PDU session for the second PEGC.
